(19) United States
(12) Patent Application Publication
(10) Pub. No.: US 2021/0300551 A1
(43) Pub. Date: Sep. 30, 2021

(54) SYSTEMS AND METHODS FOR UNMANNED AERIAL SYSTEM COMMUNICATION

(71) Applicant: TENCENT AMERICA LLC, Palo Alto, CA (US)

(72) Inventors: Shuai ZHAO, Pleasanton, CA (US); Stephan WENGER, Hillsborough, CA (US); Paul Spencer DAWKINS, Garland, TX (US)

(73) Assignee: TENCENT AMERICA LLC, Palo Alto, CA (US)

(21) Appl. No.: 17/085,083

(22) Filed: Oct. 30, 2020

Related U.S. Application Data
(60) Provisional application No. 62/994,576, filed on Mar. 25, 2020.

(51) Int. Cl. B64C 39/02; G08G 5/00

(52) U.S. Cl. CPC B64C 39/024; G08G 5/006; G08G 5/0013; G08G 5/0069

(57) ABSTRACT

Systems and methods may provide unmanned aerial system (UAS) communication, a method performed by a UAS includes obtaining first digital information that indicates a position of an unmanned aerial vehicle (UAV) of the UAS; obtaining second digital information that identifies a zone of a Notice to Airmen (NOTAM); determining whether an airspace violation has occurred by comparing the position of the UAV with the zone of the NOTAM, based on the first digital information and the second digital information; and controlling the UAS to warn a user of the UAS about the airspace violation occurring or potentially occurring, or controlling the UAV to auto return or land, based on the determining.

### CROSS-REFERENCE TO RELATED APPLICATION

This application claims priority from U.S. Provisional Application No. 62/994,576, filed on Mar. 25, 2020, the disclosure of which is incorporated herein by reference in its entirety.

### FIELD

Embodiments of the present disclosure relate to systems and methods for operation of unmanned aerial systems, and more specifically, to the storage of onboard charts in an unmanned aerial system (UAS), update of the onboard charts over a network in real-time, and correlation of a unmanned aerial vehicle's (UAV's) position with the chart data to identify whether the UAV's flight is legal.

### BACKGROUND

At present, a UAV does not obtain real-time information concerning whether its flight is legal from an airspace viewpoint, and may, therefore, operate in restricted airspace without permission. Because UAV pilots may not need to be licensed, they may not even know what restricted airspace is, or how to avoid it. Technical means to at least inform a pilot and/or avoid flight into restricted airspace may therefore be required.

### SUMMARY

Embodiments of the present disclosure may solve the above problems and/or other problems.

According to one or more embodiments, a method performed by an unmanned aerial system (UAS) is provided. The method includes obtaining first digital information that indicates a position of an unmanned aerial vehicle (UAV) of the UAS; obtaining second digital information that identifies a zone of a Notice to Airmen (NOTAM); determining whether an airspace violation has occurred by comparing the position of the UAV with the zone of the NOTAM, based on the first digital information and the second digital information; and controlling the UAS to warn a user of the UAS about the airspace violation occurring or potentially occurring, or controlling the UAV to auto return or land, based on the determining.

According to an embodiment, the second digital information includes one or more parameters that indicate at least one from among a location coordinate of the zone, a radius of the zone, an effective date of the NOTAM, a ceiling of the zone, a floor of the zone, and a status of exemption of the UAV from a prohibition of the NOTAM.

According to an embodiment, the NOTAM is a Temporary Flight Restriction (TFR).

According to an embodiment, at least a portion of the second digital information is in a JavaScript Object Notation (JSON) format.

According to an embodiment, at least a portion of the second digital information has a dictionary data type.

According to an embodiment, the obtaining the second digital information includes obtaining, by the UAV, the second digital information via a first wireless connection to a network that is external to the UAS, and the determining whether the airspace violation has occurred is performed by at least one processor of the UAV.

According to an embodiment, the obtaining the second digital information includes obtaining, by a controller of the UAS, the second digital information via a first wireless connection to a network that is external to the UAS, the controller includes at least one processor and is configured to control the UAV via a second wireless connection to the UAV, and the determining whether the airspace violation has occurred is performed by the at least one processor of the controller of the UAS.

According to an embodiment, the UAS includes the UAV and a controller configured to control the UAV via a first wireless connection, each of the UAV and the controller including at least one processor, the obtaining the second digital information includes obtaining, by one from among the UAV and the controller, the second digital information via a second wireless connection to a network that is external to the UAS, and the determining whether the airspace violation has occurred is performed by the at least one processor of the other from among the UAV and the controller.

According to an embodiment, the method further includes updating an aeronautical chart, that is stored in the UAS, with the second digital information that is obtained.

According to an embodiment, the obtaining the second digital information includes obtaining the second digital information from a server, via a wireless connection to a network that is external to the UAS.

According to one or more embodiments, an unmanned aerial system (UAS) is provided. The UAS includes an unmanned aerial vehicle (UAV); and a controller configured to wirelessly communicate with the UAV and control the UAV, wherein at least one from among the UAV and the controller includes: at least one processor; and memory including computer code. The computer code is configured to, when executed by the at least one processor, cause the at least one processor to: determine whether an airspace violation has occurred by comparing a position of the UAV with a zone of a Notice to Airmen (NOTAM), based on first digital information and second digital information obtained by the at least one processor, and warn a user of the UAS about the airspace violation occurring or potentially occurring, or controlling the UAV to auto return or land, based on the determination. The first digital information indicates the position of the UAV, and the second digital information identifies the zone of the NOTAM.

According to an embodiment, the second digital information includes one or more parameters that indicate at least one from among a location coordinate of the zone, a radius of the zone, an effective date of the NOTAM, a ceiling of the zone, a floor of the zone, and a status of exemption of the UAV from a prohibition of the NOTAM.

According to an embodiment, the NOTAM is a Temporary Flight Restriction (TFR).

According to an embodiment, at least a portion of the second digital information is in a JavaScript Object Notation (JSON) format.

According to an embodiment, at least a portion of the second digital information has a dictionary data type.

According to an embodiment, the UAV is configured to obtain the second digital information via a wireless connection to a network that is external to the UAS, and the UAV includes the memory and the at least one processor, and the UAV is configured to determine whether the airspace violation has occurred based on the first digital information and the second digital information.

According to an embodiment, the controller is configured to obtain the second digital information via a first wireless connection to a network that is external to the UAS, and the controller includes the memory and the at least one processor, and the controller is configured to determine whether the airspace violation has occurred based on the first digital information and the second digital information.

According to an embodiment, one from among the UAV and the controller is configured to obtain the second digital information via a wireless connection to a network that is external to the UAS, and the other from among the UAV and the controller includes the memory and the at least one processor and is configured to determine whether the airspace violation has occurred based on the first digital information and the second digital information.

According to an embodiment, the computer code is further configured to, when executed by the at least one processor, control the at least one processor to update an aeronautical chart, that is stored in the UAS, with the second digital information that is obtained.

According to one or more embodiments, a non-transitory computer-readable medium storing computer code is provided. The computer code is configured to, when executed by at least one processor of an unmanned aerial system (UAS), cause the at least one processor to: determine whether an airspace violation has occurred by comparing a position of an unmanned aerial vehicle (UAV) of the UAS with a zone of a Notice to Airmen (NOTAM), based on first digital information and second digital information obtained by the at least one processor of the UAS; and warn a user of the UAS about the airspace violation occurring or potentially occurring, or control the UAV to auto return or land, based on the determination. The first digital information indicates the position of the UAV, and the second digital information identifies the zone of the NOTAM.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an unmanned aerial system (UAS).

FIG. 2 is a schematic illustration of a UAS that includes UAS communication with a UAS service system.

FIG. 3 is a schematic illustration of a first chart.

FIG. 4 is a schematic illustration of a second chart.

FIG. 5 is a schematic illustration of a system, including a UAS, in accordance with an embodiment.

FIG. 6 is a schematic illustration of a system, including a UAS, in accordance with an embodiment.

FIG. 7A is a schematic illustration of a RESTful position query in accordance with an embodiment;

FIG. 7B is a schematic illustration of a JSON reply in accordance with an embodiment.

FIG. 8A illustrates a first portion of a parameter table.

FIG. 8B illustrates a second portion of the parameter table.

FIG. 9 is a schematic illustration of computer code of a UAS in accordance with embodiments.

FIG. 10 is a schematic illustration of a computer system in accordance with an embodiment.

### DETAILED DESCRIPTION

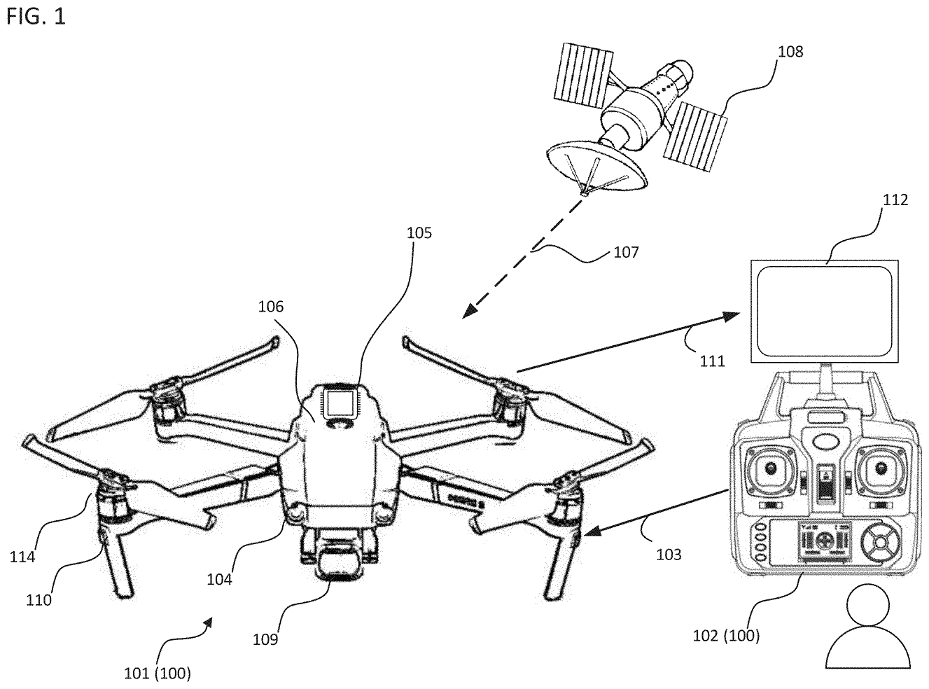

Referring to FIG. 1, an unmanned aerial system (UAS) (100) can include an unmanned aerial vehicle (UAV) (101) and a controller (102). The controller (102) can use a data link (103) to communicate control commands from the controller (102) to the UAV (101). The controller (102) may include at least one communication circuit that is configured to provide communication, that constitutes the data link (103), via very high frequency (VHF), ultra-high frequency (UHF), or other wireless technology that is analog or digital radio conveying. The controller (102) via the data link (103) may control power levels of the engines (114) of the UAV (101) or control surfaces of the UAV (101). More abstract commands like pitch, yaw, and roll, similar to those of helicopters or aircraft, can also be used. An experienced pilot can operate some UAVs with those basic controls, not relying on any advanced onboard processing of control signals inside a UAV. UAVs have been available in many forms, including as helicopters and aircraft.

Advances in onboard electronic designs more recently allow the offload of certain tasks from the human operator to the UAV itself. Many UAVs, today, include sensor(s) (104) that indicate to an onboard controller (105) of the UAV (101) characteristics of the UAV (101) such as, for example, the attitude and the acceleration of the UAV (101). The onboard controller (105) can be a computer system with a scaled-down or non-existent user interface. The information obtained by the sensor(s) (104), in addition to the control inputs received from the data link (103) from the controller (102), may allow the UAV (101) to remain stable unless positive control input is obtained from the controller (102).

Even more recently, UAVs can include a receiver (106) configured to receive communication from one of the Global Navigation Satellite Systems (GNSS), such as the Global Positioning System (GPS) operated by the United States. FIG. 1 illustrates a single satellite (108) that provides a signal (107) as such communication, to represent a GNSS. However, the receiver (106) of the UAV (101) may receive communication from a GNSS that includes three or more, and typically four or more, line-of-sight satellites to triangulate the position of the UAV (101) in space. The receiver (106), which may be a GNSS receiver, may determine with fair accuracy the position of the UAV (101) in space and time. In some UAVs, a GNSS can be augmented by additional sensors (such as an ultrasonic or LIDAR sensor) of the UAV (101) on the vertical (Z-) axis to enable soft landings (not depicted). The UAV (101), according to some embodiments, may be configured to perform features such as “fly home” and “auto-land” based on GNSS capabilities, where the UAV (101) flies to a location that was defined as its home location. Such features may be performed by the UAV (101) based upon a simple command from the controller (102) (like: the push of a single button) or in case of a loss of the data link (103) from the controller (102) or other timeout of meaningful control input.

As another recent development, the UAV (101) may also include one or more cameras (109). In some cases, the UAV (101) may include a gimbal-mounted camera as one of the cameras (109) and can be used to record pictures and video of a quality sufficient for the UAV's users—today, often in High Definition TV resolution. In some cases, the UAV (101) may include other cameras (110), often covering some or all axes of movement, and the UAV (101) may be configured to perform onboard signal processing based on signals from the cameras (110) for collision avoidance with both fixed and moving objects.

In some cases, the UAV (101) may include a “main” camera as one of the cameras (109) and its camera signal can be communicated by a communication interface (e.g. communication circuit) of the UAV (101) via a data link (111) in real-time towards the human user, and displayed on a display device (112) included in, attached to, or separate from the controller (102). The data link (111) may be the same as or different from the data link (103). Accordingly, UAVs may be successfully flown out of line-of-sight of a human pilot, using a technique known as “First Person View” (FPV).

As a result of these and other technical developments, UAVs have become considerably easier to fly, which in turn has made them popular not only with professional UAV pilots and determined and affluent hobbyists, but also the general public. As a result, millions of UAVs are now sold every year compared to a few thousand—if that many—model helicopters some 15 years ago. At the same time, the knowledge, proficiency, and engagement of the user community, on average, has decreased.

All but perhaps the smallest UAVs can present a hazard to manned aviation, not only through mid-air collisions, but also due to pilot distraction, saturation of Air Traffic Control (ATC) resources, and so on. The combination of potentially thousands of UAVs flying simultaneously during certain days, and (on average and when compared to pilots of manned aircraft) the under skilled, undereducated, under informed, and occasionally reckless UAV pilots, has led to millions of dollars spent on aborted takeoffs, missed approaches, reroutes, grounded manned aircraft, property damage through, for example, wildfires that could not be fought by manned aerial resources, and so forth. There have been reports of lives claimed by the effects of in-air collisions between amateur-piloted UAVs and helicopters. For these and other reasons, regulatory authorities including the United Nations' International Civil Aviation Organization (ICAO) and the United States' Federal Aviation Administration (FAA) have started to regulate UAVs, including smaller UAVs weighing less than 55 pounds. Heavier UAVs have historically been regulated already.

In the US, one aspect of such regulation is the requirement for a pilot carrying a “Remote Pilot Certificate” when conducting substantially all commercial (for hire) UAV operations. The certificate is not primarily targeted towards the mechanical aspects of flying a UAV, but rather towards an understanding and the observance of regulations including, for example, airspace, flight restrictions, and so forth. While a commercial remote pilot may, through obtaining the certificate, be aware of his/her obligations with respect, among other things, observance of rules and regulations of UAV operations, including airspace, a hobbyist may not be sufficiently aware. UASs have become so cheap and easy to operate that the historical way of achieving competency through model aircraft clubs and similar organizations does not reliably work anymore either. For example, a substantial number of UAVs are operated away from the flying fields that model aircraft clubs maintain, by individuals who were never a member of such a club and likely have never studied pertaining regulations, let alone got a briefing regarding the current layout of the airspace.

Another aspect that is proposed for regulation includes the identification of UAVs and their flights to ATC, other UAVs, and so forth. In the US, a “proposed rule” (Document No. 2019-28100) has been published on Dec. 31, 2019, by the FAA, which is entitled “Remote Identification of Unmanned Aircraft Systems”. The proposed rule, when implemented by substantially all UASs, will give the ATC a certain insight into UAV activity at any given moment in time. The proposed rule further requires the UAS to be equipped to inform the pilot if the reporting mechanism between the UAS and the systems interfacing with the ATC, known as UAV Service Suppliers (USS), is inactive while the UAV is airborne. However, contrary to many operations of manned aircraft in controlled airspace that require the flight crew to be in (voice) contact with the ATC, squawk transponder codes, and so forth, no such requirement is envisioned in the proposed rule, nor would it likely be practical without a substantial increase in ATC resources. Insofar, while the FAA through USSs may be able to obtain a certain amount of real-time knowledge of active UAV operations, the “proposed rule” does not envision direct (through technical means) or indirect (through communication with the pilot) influence of the UAV's flight by an ATC. Instead, the proposed rule targets informing the ATC about UAV operations pertaining to the ATC's mission.

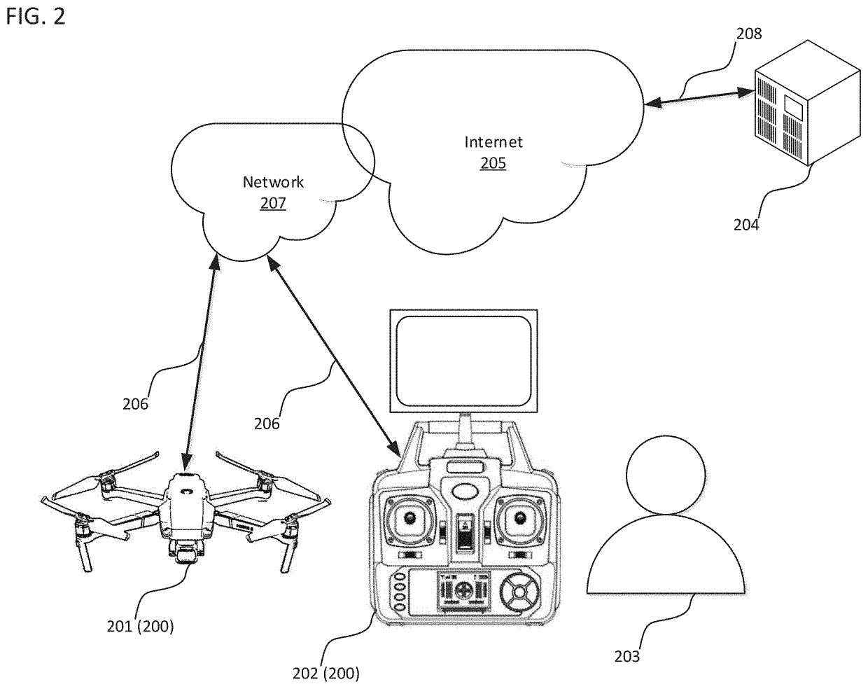

Referring to FIG. 2, a UAS (200) may include a UAV (201) and a controller (202). The UAV (201) and the controller (202) may be the same or similar to the UAV (101) and the controller (102) illustrated in FIG. 1, respectively. According to an embodiment, the UAS (200), potentially operated by a human pilot (203), may be configured to inform one or more USSs (204) about the position of the UAV (201) in real-time in accordance with the “proposed rule”. The reporting can be conducted using the Internet (205). For all but the most exotic use cases involving tethered UAVs, this may imply that one or both of the UAV (201) and the controller (202) of the UAS (200) may configured to have a connection (206) over a wireless network such as a network (207) (e.g. 5G Network) to the Internet (205), and the USS (204) also may have a connection (208) to the Internet (205). Such a scenario may be assumed for the proposed rule, and may be assumed herein as well, but embodiments of the present disclosure are not limited thereto. Networks other than the Internet (205) may also be used. For example, conceivably, a closed wireless network that is not the Internet could be used to communicate between the UAS (200) and the USS (204). Closed wireless networks may be used for certain military UAVs. When referring to the “Internet” henceforth, such networks are meant to be included.

Many physical wireless network technologies may be deployed in uses that enable connections (206) (e.g. wireless connections) and networks (207) (e.g. wireless networks) to connect systems such as the controller (202) or the UAV (201) of the UAS (200) to the Internet (205). For outdoor applications, mobile networks may be used such as, for example, 5th Generation or “5G” networks. Henceforth, the use of such a 5G network may be assumed but embodiments of the present disclosure are not limited thereto. Other physical network technologies can equally be employed, including for example, 3G, 3.5G, 4G, LTE mobile networks, wireless LAN in infrastructure or ad hoc mode, zig-bee, and so on. In embodiments of the present disclosure, a mobile network carrying the Internet can offer bi-directional communication, such as, for example, between the UAS (200) and the USS (204). The quality of service in each direction may differ however. According to embodiments of the present disclosure, the UAV (201), the controller (202), and/or the USS (204) may include communication interfaces (including for example, a transmitter and/or a receiver) and at least one processor with memory that implements one or more of the physical wireless network technologies, so as to be configured to communicate via one or more of the network types of the present disclosure.

With reference to FIG. 2, the connections (206) between the Internet (205) through a network (207) (e.g. a 5G network) to the UAV (201) and/or the controller (202) can be bi-directional. When using Internet protocols such as Internet Protocol (IP), Transmission Control Protocol (TCP), User Datagram Protocol (UDP), Hypertext Transfer Protocol (HTTP), Quick UDP Internet Connections (QUIC), and similar, for the communication between the UAS (200) and the USS (204) (as may be envisioned by the proposed rule), then by the nature of such protocols, a bi-directional link may be required for those protocols to work. Further, the proposed rule includes a requirement that the human pilot (203) be informed, presumably by the controller (202) or the UAV (201) itself of the case of communication loss between the UAS (200) and the USS (204), which may be achieved through a data link between the USS (204) and the UAS (200)—which in turn may require bi-directional communication. Accordingly, the connections 206 may be bi-directional for such reasons.

Air traffic control (ATC) authorities such as the FAA, or government or private authorities or entities tasked by the ATC authorities, have previously issued not only regulations but also various forms of graphic, textual, or verbal information regarding the layout of the airspace in which (manned and unmanned) aircraft operate. Historically, at various times available in the form of printed charts, weekly publications, and textual information (e.g. available through fax, over the telephone, or in person by a flight service specialist), relevant information is now, in most countries including the US, available over the Internet, albeit from various sources. As an example, such relevant information may include the following:

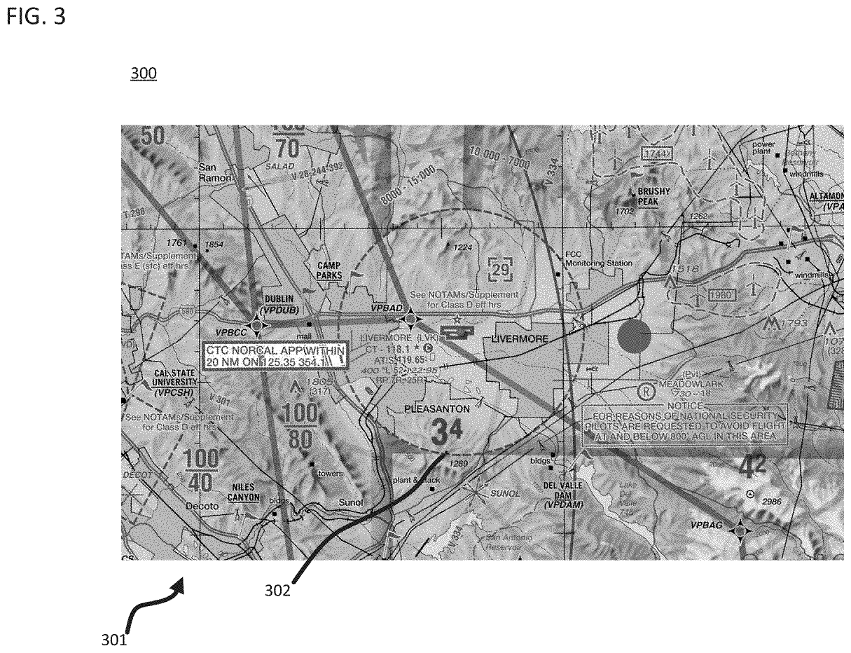

(A) Charts: many different types of aeronautical charts are available in different countries and for different purposes (e.g. low/high altitude, visual/instrument flight rules, planning, etc.). For the operation of small UAVs, of particular relevance are the US sectional charts, as well as the “Low Altitude Authorization and Notification Capability” (LAANC) information, which may be displayed in the form of a chart on a web browser. Charts may be updated on a comparatively long-term cycle (for example; VFR sectional charts: every six months). For manned aircraft, the use of an “in force” chart may be required. Referring to FIG. 3, an excerpt of a sectional chart (300) centered on Livermore Airport in California (301) is illustrated. It should be noted that sectional charts are colored, and the color carries significance. However, the black-and-white representation of the sectional chart (300) is sufficient to show the difficulties that a recreational UAV pilot may have in interpreting sectional charts. The dashed circle (approximately 8 miles in diameter) around the airport indicates an airspace (302), which is a “Class D” airspace at certain times (when the toward of Livermore airport is open), which can imply that no (manned) aircraft operation is allowed inside this circle and up to a certain altitude without prior approval by ATC. Historically, the same rule applied to UAVs, which resulted in the flights of UAVs in most parts of the Livermore township (to the east/right of Livermore airport) and surrounding areas being illegal.

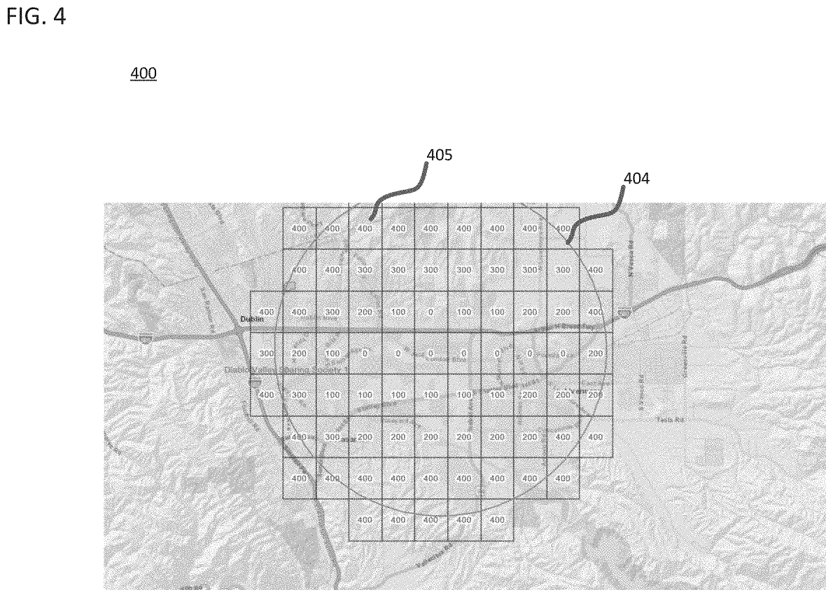

Recognizing the requirements for manned aircraft operations were perhaps overly restrictive for recreational drones, the FAA has recently allowed flying recreational drones in certain parts of controlled airspace. With reference to FIG. 4, a portion of a chart (400) is illustrated, which is an example of a “UAV chart” issued from the FAA electronically over the Internet, and displayed in a web browser. Again, colors in such charts may be significant, but the black/white representation is sufficient to show aspects of the chart (400) for purposes of the present disclosure. As illustrated in FIG. 4, similar to FIG. 3, an 8 mile circle is provided around Livermore airport, which indicates an airspace (404). In the original version of the chart (400), the circle is depicted in blue. Areas covered by the circle (indicative of controlled airspace), are covered by blocks (405) that are rectangular. Each such block (405) may be around one square mile in size. Each block (405) may contain an identifier (e.g. a number) which is indicative of the maximum allowed altitude a UAV is allowed to fly within the block (405) without prior permission. Mechanisms (in the form of apps) may be in place that allow certain UAV operators to obtain permission to fly higher than a ceiling of a block that is indicated by the identifier.

(B) Notice to Airmen (NOTAM): these textual notices may have an internationally recognized standardized format and may be written in plain English. The textual notices can be issued quickly—within minutes or hours—unlike charts that may have update cycles measured in weeks and months, but their valid time can be varying from hours to “indefinitely” or “until further notice”. One of many purposes of NOTAMs can be to update certain aspects of charts. For example, aeronautical charts can include information about navigation obstacles such as high towers. When a temporary crane gets erected that is higher than a certain threshold (which is determined, among other factors, by the closeness of the site to the approach path of existing airports), it may constitute a navigation hazard and, as such, its existence, location, height, and anticipated duration of existence may be made available in the form of NOTAMs. An example of a NOTAM that indicates the presence of a crane in the vicinity of an airport (San Carlos, KSQL) may look as follows:
KSQL SAN CARLOS
!SQL 10/003 SQL OBST CRANE (ASN 2018-AWP-13591-OE) 372917N1221327 W (1.9NM SE SQL) 309FT (300FT AGL) FLAGGED AND LGTD 1910072355-2001312159
CREATED: 7 Oct. 2019 23:55:00
SOURCE: SQL

(C) Temporary Flight Restrictions (TFRs): A TFR is a type of a NOTAM that can inform a pilot or crew of an airspace where special ATC permission may be required to enter. TFRs can be announced well in advance (for example, to cover areas above long-planned sports events), or issued in real time (for example, in case of wildfires). Shown below is an example of a TFR that could be related to a fire or similar hazard; the TFR may only be valid for a single hour:
FDC 9/1767 ZMP MN.AIRSPACE HIBBING, MN.TEMPORARY FLIGHT RESTRICTIONS WI AN AREA DEFINED AS 2 NM RADIUS OF 472601N0930200 W (HIBBING VOR/DME HIB299015.6) SFC-4500FT BLASTING. PURSUANT TO 14 CFR SECTION 91.137(A)(1) TEMPORARY FLIGHT RESTRICTIONS ARE IN EFFECT. ONLY RELIEF ACFT OPS UNDER DIRECTION OF HIBBING TACONITE ARE AUTH IN THE AIRSPACE. HIBBING TACONITE TELEPHONE 218-262-5940 IS IN CHARGE OF ON SCENE EMERG RESPONSE ACT. MINNEAPOLIS/ZMP/ARTCC TELEPHONE 651-463-5580 IS THE FAA CDN FACILITY. 2001031630-2001031730

In the US and in many other countries, all the above information can be obtained in digital format. In the US, such access can be free of charge. The data format of the above information may be standardized, published, and quite compact. All aforementioned US data pertaining to a given day may fit into 16 GB.

The FAA is transitioning the National Airspace System (NAS) to Performance Based Navigation (PBN), which primary uses satellite navigation in the form of the Global Navigation Satellite System (GNSS). GPS (Global Positioning System) is one the systems of GNSS, which is a system used for worldwide navigation and surveying. The GPS system may make use of the geographical latitude and longitude lines to provide coordinates for a person's location or a place of interest. Lines of latitude are horizontal lines that stretch from east to west across the globe. The longest and main line of latitude is called the Equator. The Equator is represented as 0° latitude. Lines of longitude are vertical lines that stretch from the North Pole to the South Pole. The main line of longitude is called the Prime Meridian. The Prime Meridian is represented as 0° longitude. Most locations on the Earth do not fall along the lines of latitude or longitude, but within the shapes created from the intersection of the horizontal and vertical lines.

In order to accurately pinpoint a human being on the Earth's surface, the lines of latitude and longitude are further divided and expressed in at least one of the three common formats: Degrees, minutes, and seconds (DMS). The common way to represent a GPS coordinate may be in the format of a pair of Latitude (N/S) and Longitude (E/W). N(orth)/S(outh) may be placed at the end of each DMS to represent if it is either on the North or South of the Equator. E(ast)/W(est) may be placed at the end of each DMS to represent if it is either on the left of the Prime Meridian or right of the Prime Meridian. The space between each line of latitude or longitude, representing 1°, is divided into 60 minutes, and each minute is divided into 60 seconds. An example of a GPS coordinate may look like the following: (25° 24′10.1″N, 20° 15′16.5″E).

As described above, interpreting airspace using traditional means designed for manned aircraft is difficult and requires a certain amount of training. While the FAA increasingly makes available simplified charts (like the chart 400), apps, and other tools designed for non-professionals, such tools continue to be difficult to operate, and perhaps more importantly, require the UAV pilot to actually consult them before flying his/her UAV. The many recent incidents related to UAVs in controlled airspace clearly indicate that not all UAV pilots do so.

Further, especially with relatively small UAVs, it can be hard for an untrained (or even trained) UAV pilot to gauge the altitude that his/her UAV is flying. For example, it previously has been difficult for a UAV pilot to know that his/her small UAV is 90 ft. in altitude (which may be legal in certain areas as indicated by a UAV chart) or 110 ft. (which may be illegal). Technical systems may be needed to be built into a UAV (e.g. UAV (201)) or a controller (e.g. controller (202)) to help solve such problems.

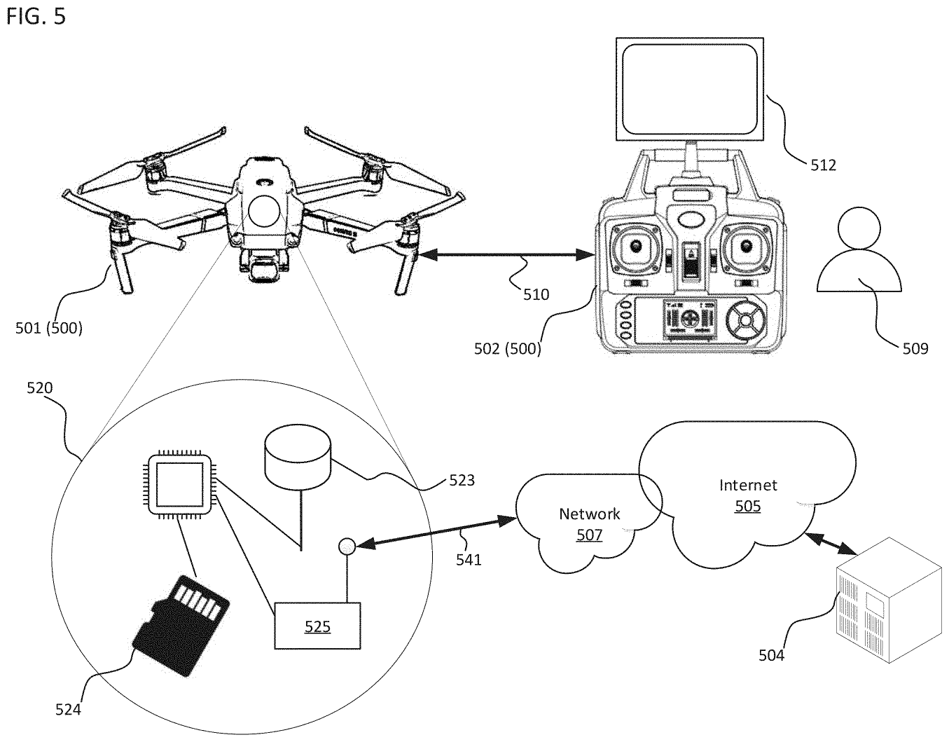

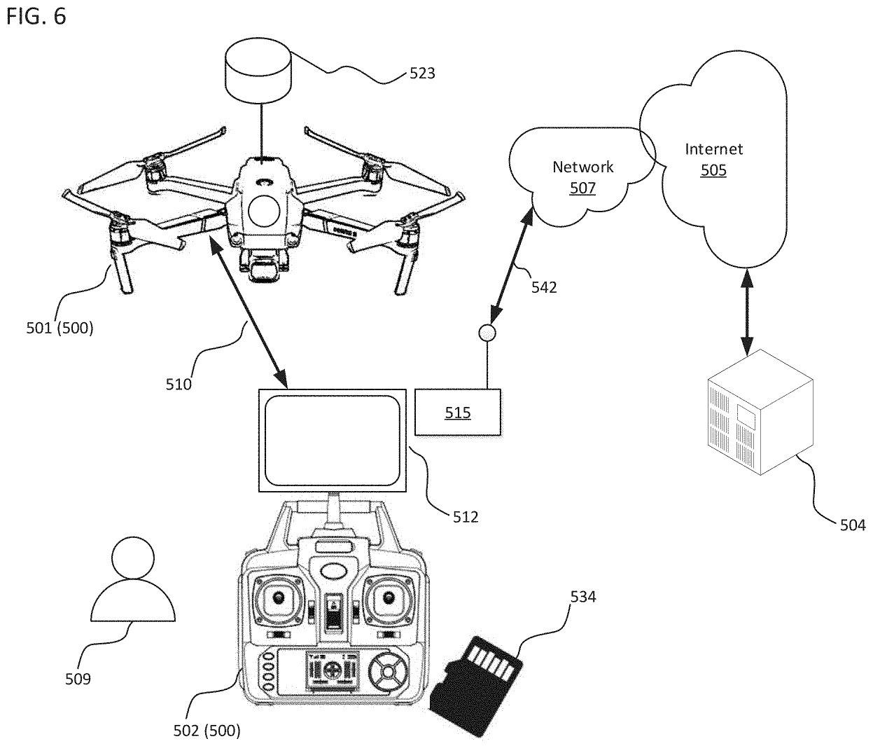

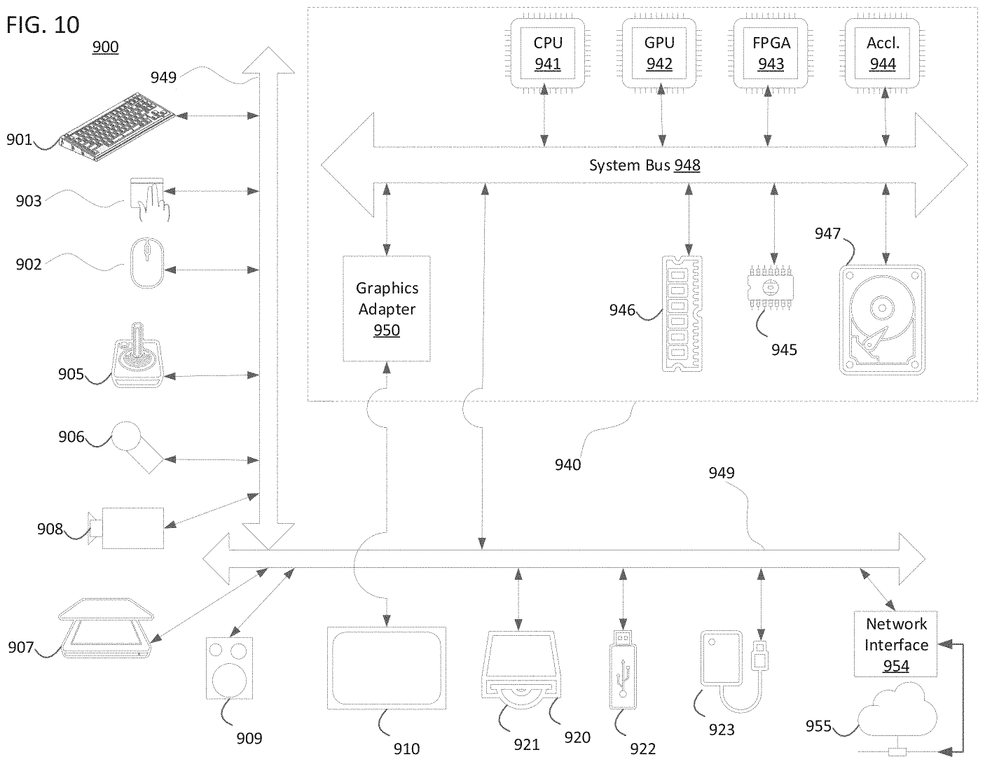

Referring to FIGS. 5-6, in an embodiment of the present disclosure, a system may be provided. The system may include a UAV (501) and a controller (502), that together constitute a UAS (500). The UAV (501) and the controller (502) may include any number of the hardware (e.g. cameras and communication interfaces) and software components described with respect to the UAS (100) and the UAS (200) illustrated in FIGS. 1-2, and may be configured to perform the functions described with respect to the UAS (100) and the UAS (200). According to embodiments, with reference to FIG. 5, the UAV (501) may include a computer system (520) that includes at least one processor and memory storing computer code, wherein the computer code is configured to cause the UAV (501) to perform its functions when executed by the at least one processor of the UAV (501). The computer system (520) may be implemented by any number of the components of computer system (900) described later below with reference to FIG. 10, and may exclude most user interface components illustrated in FIG. 10. The computer system (520) may be an embedded system and may advantageously (for space and weight reasons) be part of, or integrated into, the onboard flight control circuitry of the UAV (501). The computer system (520) may have a mechanism to obtain its location in three-dimensional space. For example, the computer system (520) may include a GPS antenna (523) that, together with a GPS receiver, may be one example of such mechanisms. The computer system (520) may include other mechanisms such as, for example, a combination of GPS with (potentially more accurate) barometric altitude sensors, a triangulation mechanism to determine a lateral position from ground-based navigation tools (omnidirectional range navigation systems (VORs), cell phone towers, etc.), and so forth. The UAV (501) may also include memory storage (524) accessible by the user (509) of the UAV (501). For example, as illustrated in FIG. 5, the memory storage (524) may be a micro-SD card. However, the memory storage (524) could also be another changeable semiconductor storage, onboard NV-RAM in the UAV (501) that is accessible through a network plug from a computer or wireless LAN, and so forth.

The controller (502) may also include a computer system that includes at least one processor and memory storing computer code, wherein the computer code is configured to cause the controller (502) to perform its functions when executed by the at least one processor of the controller (502). The computer system of the controller (502) may be implemented by any number of the components of computer system (900) described later below with reference to FIG. 10. With reference to FIG. 6, the controller (502) may include a memory storage (534) accessible by the user (509) of the controller (502). The memory storage (534) may have a same or similar configuration as the memory storage (524). According to embodiments, one, none, or both of the memory storage (524) and the memory storage (534) may be included in the UAS (500).

The memory storage (524) and/or the memory storage (534) may have at least a sufficient size to store information pertaining to the airspace(s) the UAV may operate in. Such information may include digital representations of charts, NOTAMs, TFRs and so forth. The digital information may be interpreted by the computer system (520) of the UAV (501) and/or the computer system of the controller (502), and may be compared (e.g. correlated) with the position of the UAV (501) in three dimensions (including lateral position and altitude). The computer system (520) of the UAV (501) and/or the computer system of the controller (502) may determine, as a result of the comparison (e.g. correlation) process, that the UAV (501) is “legal to fly” or “not legal to fly” in the airspace that the UAV (501) currently occupies. Alternatively or additionally, the computer system (520) of the UAV (501) and/or the computer system of the controller (502) may determine other results such as “legal to fly but approaching the legal airspace boundary”, “legal to fly but will be illegal within 10 seconds if course is not altered”, and so forth. The memory storage (524) and/or the memory storage (534) may be loaded with digital information pertaining to the airspace(s) the UAV (501) is anticipated to fly in.

The UAS (500) may obtain the digital information (or additional digital information that may update the digital information) pertaining to the airspace(s), during power-up, pre-flight, or flight, of the UAV (501), by one or more from among the wireless connection (541) and the wireless connection (542). For example, with reference to FIG. 5, the UAV (501) of the UAS (500) may be configured to have a wireless connection (541) over a wireless network such as a network (507) (e.g. a 5G Network) to the Internet (505), and the USS (504) may have a connection to the Internet (505). Alternatively or additionally, with reference to FIG. 6, the controller (502) of the UAS may be configured to have a wireless connection (542) over a wireless network such as the network (507) (e.g. a 5G Network) to the Internet (505), and the USS (504) may have a connection to the Internet (505). Accordingly, the UAV (501) and/or the controller (502) of the UAS (500) may be configured to communicate with the USS (504) and/or similar servers operated by relevant authorities over airspace, or designated thereof, via the Internet (505). Via the wireless connection (541) and/or the wireless connection (542), the UAS (500) may query the USS (504) and/or the similar servers, and receive the digital information (or additional digital information) pertaining to the airspace(s) from the USS (504) or the similar servers.

For example, according to embodiments, the UAV (501) and/or the controller (502) may query the USS (408) (and/or the similar servers) for one or more of the following, which the UAV (401) and/or the controller (502) may then obtain and store in the memory storage (524) and/or the memory storage (534):

(A) Charts: In a case that the UAV (501) or the controller (502) determines that onboard charts in the memory storage (524) and/or the memory storage (534) for a relevant area(s) are not current (e.g. aeronautical charts may carry an expiration date); the UAS (500) may query for and obtain charts pertaining to a particular area that is identified by the UAS (500). For example, the particular area may be a geographical location (e.g. a location of the UAS (401)) that is obtained by the UAS (500) from the GPS antenna (523), or other geo-reference data, including a reasonable radius around the UAV's (501) current location wherein the reasonable radius may be calculated by the UAV (501) or the controller (502) based on the endurance (e.g. maximum flight time) of the UAV (501), a maximum speed of the UAV (501), and a safety factor to accommodate for wind and other environmental factors.

(B) NOTAMs: The UAS (500) may query for and obtain NOTAMs pertaining to a particular area that is identified by the UAS (500), wherein the particular area may be the same or similar as the particular areas described above.

(C) TFRs: The UAS (500) may query for and obtain TFRs pertaining to a particular area that is identified by the UAS (500), wherein the particular area may be the same or similar as the particular area described above.

(D) Other Information: The UAS (500) may query for and obtain other information relevant for the flight of the UAV (e.g. pertaining to the particular area that is identified by the UAS (500)). For example, the other information may include weather data, including, for example, wind data. According to embodiments, the weather data may be used by the UAS (500) to determine the safety factor for calculating the reasonable radius around the UAV's (501) current location.

Information received using the aforementioned mechanisms can be integrated with the onboard information in the memory storage (524) and/or the memory storage (534) and used as described further below.

Details of protocols used for the communication between the UAS (500) (e.g. the UAV (501) or the controller (502)) and the USS (504), or other servers, may depend on the services offered by the USS (504) or the other servers. Historically, NOTAMs (e.g. TFRs), as an example, were available in files covering geographic areas of air traffic control centers (several US states in size). According to embodiments of the present disclosure, the UAS (500) (e.g. the UAV (501) or the controller (502)) may (a) request the file corresponding to the state the UAV (501) is operating in (e.g. as identified by the UAS (500) based on GPS location and an onboard chart), (b) download the pertinent textual NOTAM file (which can be a few ten or perhaps 100 Kbyte in size) using protocols such as FTP, or HTTP, (c) parse the file for relevant information, and (e) integrate the relevant information identified with onboard chart information in the memory storage (524) and/or the memory storage (534). Such a process may occur at least once before the flight, but also several times during the flight, for example in 1-minute or 5-minute intervals. Such process may be practical due to the comparatively small file size. Other access mechanisms of the present disclosure, described below, may be even more efficient.

More recently, airspace authorities including the FAA have implemented modern query interfaces that allow automated download of information pertinent to a specific location with a granularity much finer than a state. These interfaces can be based on RESTful operations. Representational State Transfer (REST), is a technique in which a client can query a server identified by a base Unified Resource Indicator (URI) through standard HTTP methods (including, for example, GET, POST, PUT, PATCH, or DELETE) in a defined format. One such defined standardized format is known as Java Object Notation (JSON).

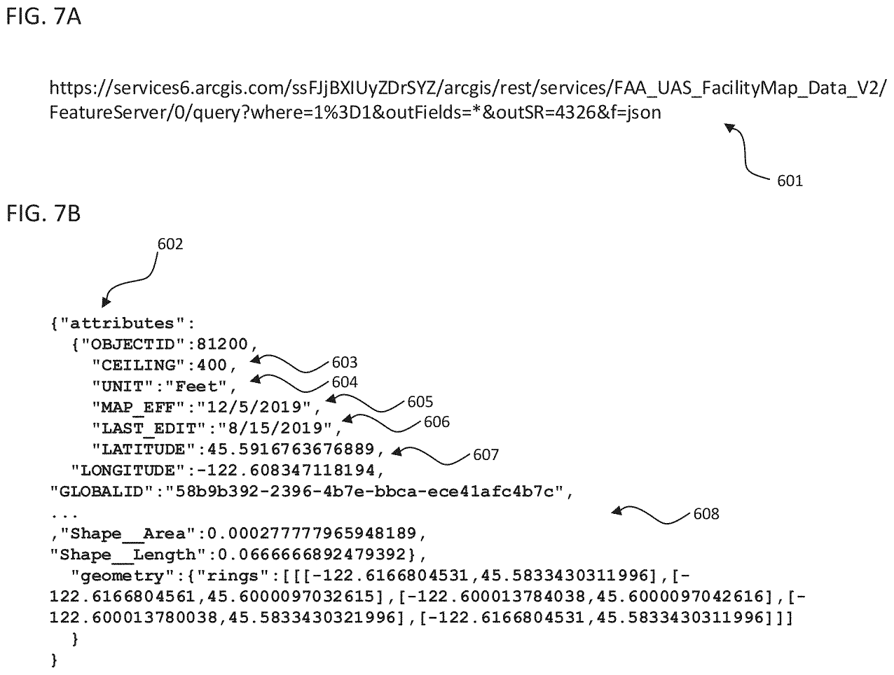

According to embodiments of the present disclosure, with reference to FIGS. 7A-B, the UAS (500) (e.g. the UAV (501) or the controller (502)) may provide a RESTful query (601) to an FAA-designed USS server (e.g. USS 504) pertaining to a UAV chart, and may, in response, receive a JSON-coded response (602) of the server. For example, as shown in FIG. 7B, the JSON-coded response (602) indicates information such as a “ceiling” (603) in units of feet (604). The “ceiling” (603) may be a maximum allowed altitude for the UAV (501). The JSON-coded response (602) may also indicate information such as the effective date (605) of the UAV chart and the last edit date (606) of the UAV chart (from which the expiration date of the UAV chart can be derived by the UAS (500)), and the location (607) and shape (608) of the spatial area to which the ceiling (603) applies.

Queries by the UAS (500) for NOTAMs (e.g. TFRs), and/or other real-time updated information can have similar formats.

Due to the comparatively small size of both query messages and replies (e.g. as shown in the example of FIGS. 7A-B), and the comparatively low computational requirements for processing such messages when compared to parsing text files of many Kbyte in size, such a query mechanism can be more suitable for a UAV compared to full file download and parsing. There are also arguably no privacy concerns because, according to the proposed rule, a UAV needs to inform a USS about its position anyway.

With reference to FIG. 5, the computer system (520) of the UAV (501) may include a communication interface that includes, for example, one or more communicators such as a communicator (525), which may include, for example, a 5G antenna. The communicator (525) may be configured to send data to and receive data (e.g. the information pertaining to the airspace(s)) from the Internet (505) by using the network (507). The communicator (525), or another communicator of the communication interface of the UAV (501), may be configured to send data (e.g. sensor data, video data, the information pertaining to the airspace(s)) to and receive data (e.g. command data) from the controller (502) via a wireless connection (510). The controller (502) may also have a communication interface with a communicator that is configured to send data (e.g. commands) to and receive data (e.g. sensor data, video data, the information pertaining to the airspace(s)) from the UAV (501) via the wireless connection (510). With reference to FIG. 6, a communicator (515) of the controller (502), or another communicator of the communication interface of the controller (502), may be configured to send data to and receive data (e.g. the information pertaining to the airspace(s)) from the Internet (505) by using the network (507). Each communicator of the present disclosure may include, for example, a transmitter and a receiver.

According to embodiments, the UAS (500) may be configured to receive the digital information pertaining to the airspace(s). According to embodiments, the UAS (500) may be configured to communicate the digital information pertaining to the airspace(s) between the UAV (501) and the controller (502). According to embodiments, the UAV (501) and/or the controller (502) may be configured to make determinations (e.g. illegal flight) based on the digital information pertaining to the airspace(s). According to embodiments, the UAV (501) and/or the controller (502) may be configured to cause the UAV (501) and/or the controller (502) to warn the user (509) about the determinations, and/or cause the UAV (501) to perform actions (e.g. automatic return or land) based on the determinations. Examples of warning the user (509) of a determination is provided below.

Referring again to FIGS. 5-6, after having obtained updates to the chart information stored in the memory storage (524) and/or the memory storage (534) in accordance with any of the above described mechanisms or any other suitable mechanisms of embodiments of the present disclosure, the UAS (500) may communicate the result of the comparison (e.g. correlation) process, based on the updated chart information, to the user (509). While flying the UAV (501), the user (509) may not be particularly interested in the details that were obtained. Instead, the user (509) may be mostly interested in an indication of the event that the UAV's (501) flight is, or has become, illegal.

According to embodiments, with reference to FIG. 5, the UAS (500) may inform the user (509) by using the wireless connection (510) between the UAV (501) and the controller (502) to communicate a signal codifying the result of the comparison (e.g. correlation), and inform the user (509) through, for example, vibration of the controller (502), a visual signal such as a warning, or a message on the display (512) that may be a part of (or attached to) the controller (502). Presumably, the wireless connection (510) is available as it may be required under the proposed FAA rule. If, however, no such wireless connection is available for any reason, the UAV (501) may alternatively or additionally include onboard mechanisms that allow it to inform the user (509) of the result of the comparison (e.g. correlation) process. For example, the UAV (501) may include ground-visible warning lights. As another example, the UAV (501) may “bob” (rapid oscillating vertical motion).

Referring to FIG. 6, embodiments of the present disclosure may include an alternative or additional implementation which shifts some of the computational burden from the UAV (501) to the controller (502). For example, the controller (502), in this case, may have access to the memory storage (534) that includes (potentially updated) chart data, and may perform the aforementioned comparison (e.g. correlation) based on position information (obtained by the GPS antenna (523)) sent by the UAV (501) over the wireless connection (510). The chart data may be updated using any suitable mechanisms including the ones described above, through the communicator (515) (e.g. a 5G interface), the network (507) (e.g. a 5G network), and the Internet (505), to the USS (504). The result of the comparison (e.g. legal or not legal to fly) may become available locally at the controller (502), and may be communicated by the controller (502) to the user (509) by, for example, a visual signal (e.g. via a light), a message on the display (512), a vibration alert, or other suitable mechanisms. As the controller (502) controls the UAV (501), the result may also be made visible by the UAV (501) itself, for example by a light attached to the UAV (501) or by the UAV “bobbing”. Indicating the result of the determination by the UAV (501) may be beneficial because the user (509) may be concentrated on the UAV (501) itself rather than the user interface of the controller (502).

As mentioned above, RESTful operations for retrieving NOTAM/TFRs data may be implemented. The returned data of the RESTful operations may be in a standardized format such as JSON.

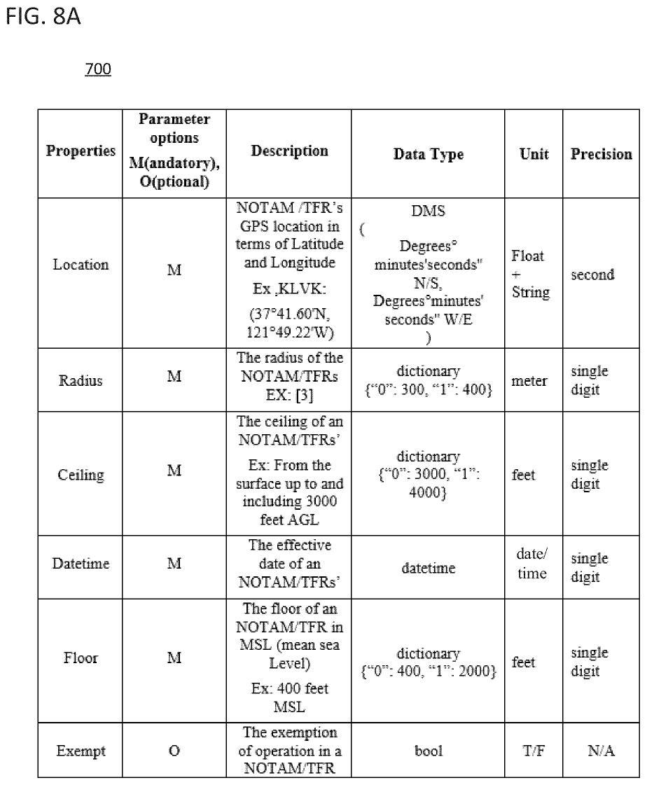

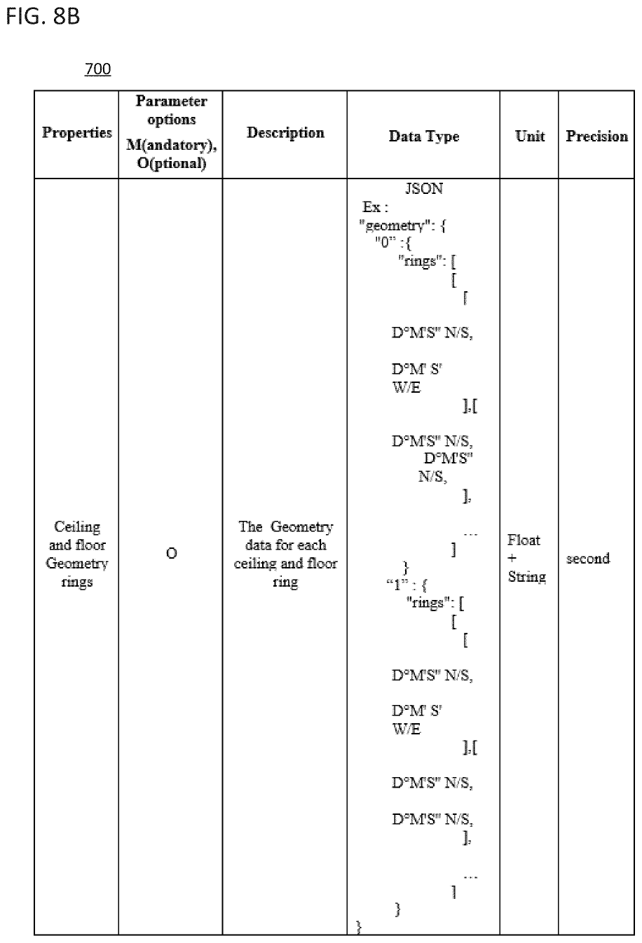

Not all returned data may be important to a UAV (501) to operate near a TFR zone. The parameters listed in the table (700), illustrated in FIGS. 8A-B, may indicate examples of digital information that may be useful to the UAS (500), and obtained by the UAS (500) via the data communication mechanisms described with respect to embodiments of present disclosure.

With reference to FIGS. 8A-B, the term “Mandatory” means conditionally mandatory. That is, if the relevant information is available, it must be included. But if it is not available, it will not be included. The designations of “Mandatory” and “Optional” in table (700) are in accordance with one non-limiting example embodiment of the present disclosure, and embodiments of the present disclosure may include various designations for each type of information. For example, any number of the properties designated as “Mandatory” in table (700) may be designated as “Optional”, and any number of the properties designated as “Optional” in table (700) may be designated as “Mandatory.” The data types, units, and precisions of the information listed in table (700) are also non-limiting examples, and the parameters may also be provided in other data types, and have different units and precisions.

With reference to table (700), NOTAM (e.g. TFR) information obtained by the UAS (500) may include properties such as, for example, “location”, “radius”, “ceiling”, “datetime”, “floor”, “exempt”, and “ceiling and floor geometry rings”.

“Location” may be information that describes a GPS location of a NOTAM (e.g. TFR) zone, and may be set to be “Mandatory.” The “location” may be a useful parameter for the UAV (501) to identify the NOTAM (e.g. TFR) zone. “Radius” may be information that describes a radius of a NOTAM (e.g. TFR) zone, and may be set to be “Mandatory”. “Ceiling” may be information that describes a ceiling of a NOTAM (e.g. TFR) zone, and may be set to be “Mandatory”. “Datetime” may be information that describes an effective date of the NOTAM (e.g. TFR), and may be set to mandatory. The “datetime” may be a useful parameter for the UAV (501) to identify a restriction timing of a NOTAM (e.g. TFR). “Floor” may be information that describes a floor of a NOTAM (e.g. TFR) zone. and may be set to be “Mandatory”. “Exempt” may be information (e.g. Boolean information) that indicates whether the UAV (501) is exempt from the NOTAM (e.g. TFR). For example, there may be times where special operations can be conducted in a NOTAM (e.g. TFR) zone such as for a critical mission in which a camera-equipped drone for video capture of a disaster situation such as wildfire may be required. The “exempt” parameter may enable the UAS (500) to indicate to the user (509) whether the UAV (501) is legal to fly in such zones. T(rue) may represent that it is legal for the UAV (501) to fly through a TFR, and F(alse) may represent that it is illegal for the UAV (501) to fly through the TFR. “Ceiling and floor geometry rings” may be geometry data for each ceiling and floor ring of a NOTAM (e.g. TFR) zone, and may be set to “Optional”.

The properties “radius”, “ceiling”, “floor”, and “ceiling and floor geometry rings” may each use a dictionary data type. All parameters which use the dictionary data type may take the key value for the same purpose. For example, for “radius” of a NOTAM (e.g. TFR) zone, if there is only one radius defined, the {key, value} pair data may be {“0”: radius}. Then, {“0”: ceiling} may represent the ceiling of the radius that is associated with the key value of “0”. Similar relationships may also be provided for the “floor” and “ceiling and floor geometry rings” data.

According to embodiments, geometry properties (e.g. “ceiling and floor geometry rings”) may be set up to be “Optional” and the “radius” may be used alone to represent the NOTAM (e.g. TFR) coverage.

In cases in which NOTAM/TFR zones do not have a regular ring boundary or have multiple ring boundary associated to it, a dictionary data type may be used for each of the parameters for “radius”, “ceiling”, and “floor”. According to embodiments, the following geometry JSON format may be used to represent each boundary:

″geometry″: {

″0” :{

″rings″: [

[

[

D°M′S″ N/S,
D°M′ S′ W/E

],[

D°M′S″ N/S,

D°M′S″ N/S,

],
...

]

}

“1” : {

″rings″: [

[

[

D°M′S″ N/S,
D°M′ S′ W/E

],[

D°M′S″ N/S,

D°M′S″ N/S,

],
...

]

}

}

The keys “0” and “1”, shown above, may represent a key value of a respective ring boundary, which also points to the same key in the information for “radius”, “ceiling”, and “floor”. As shown above, each of the keys “0” and “1” may be associated with a respective array of GPS coordinates in a DMS format, the GPS coordinates indicating information of a boundary of a ring.

The UAS (500) may obtain the above described aeronautical information from a USS/UTM and follow through a proper operation accordingly.

The UAS (500) may obtain the aforementioned information (e.g. information indicated in table (700)) from a USS/UTM (e.g. USS 504) and use the information in at least one of the following ways:

(1) During startup, the UAS (500) may query a server, for example a server co-operated with the USS (504), a LAANC server, or similar servers, to compare (e.g. correlate) with its own known position and whether it is legal to fly (and up to what altitude it is legal to fly in the anticipated visual range around its current location). The visual range may be determined by heuristics, involving, for example, the size of the UAV—a one-foot drone is hardly visible when more than a few hundred feet away. If it were illegal to fly at the current location, the UAS (500) may inform the pilot of such a situation. The UAS (500) may also inform the pilot about the maximum height that it is legal to fly (which may be particularly relevant in multi-ringed environments).

(2) In flight, the UAS (500) may correlate the position information obtained by an onboard GPS of the UAV (501). If the UAS (500) determines that the UAV (501) has entered illegal airspace, it may take corrective action, for example informing the pilot, auto-return, and/or auto-land.

UASs of the present disclosure may comprise at least one processor and memory storing computer code. The computer code, when executed by the at least one processor, may be configured to cause the at least one processor to perform the functions of the embodiments of the present disclosure.

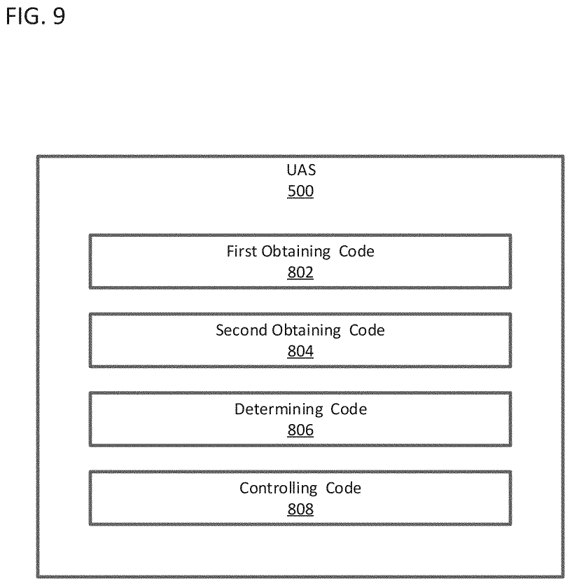

For example, with reference to FIG. 9, the UAS (500) of the present disclosure may comprise at least one processor and memory storing computer code. Any number of the at least processor and the memory may be provided in one or both of the UAV (501) and the controller (502), such that functions of the present disclosure may be performed by a single one from among the UAV (501) and the controller (502), both of the UAV (501) and the controller (502), or divided between the UAV (501) and the controller (502). The computer code may comprise first obtaining code (802), second obtaining code (804), determining code (806), and controlling code (808).

The first obtaining code (802) may be configured to cause the at least one processor to obtain first digital information that indicates a position of the UAV (501) of the UAS (500). According to an embodiment, the first digital information may include a GPS coordinate of the UAV (501). According to an embodiment, the first digital information may be obtained via GPS.

The second obtaining code (804) may be configured to cause the at least one processor to obtain second digital information that identifies a zone (e.g. a TFR zone) of a Notice to Airmen (NOTAM). According to an embodiment, at least a portion of the second digital information may be in a JavaScript Object Notation (JSON) format. According to an embodiment, at least a portion of the second digital information may have a dictionary data type. According to an embodiment, the second digital information may be obtained via a wireless connection to a network that is external to the UAS (500). According to an embodiment, the second digital information may include the digital information described above with reference to table (700) that is illustrated in FIGS. 8A-B. According to an embodiment, the UAS (500) may update information (e.g. an aeronautical chart) stored in the memory with the second digital information obtained, and the updated information may be utilized in the determinations provided by the determining code (806).

The determining code (806) may be configured to cause the at least one processor to determine whether the UAV (501) has caused an airspace violation by comparing (e.g. correlating) the position of the UAV (501) with a position of the zone of the NOTAM, based on the first digital information and the second digital information. In a case where one from among the UAV (501) and the controller (502) obtains the first and/or second digital information via a network outside the UAS (500), and the other from among the UAV (501) and the controller (502) is configured to perform the determination, the one from among the UAV (501) and the controller (502) may communicate the first and/or second digital information to the other via the wireless connection (510) from among the UAV (501) and the controller (502) so that the other from among the UAV (501) and the controller (502) may perform the determination.

The controlling code (808) may be configured to cause the at least one processor to control the UAS (500) to warn the user (509) of the UAS (500) about the airspace violation occurring or potentially occurring, or control the UAV (501) to auto return or land, based on the determination performed with the determining code (807). For example, according to an embodiment, the controller (502) may inform the user (509) of a result of the comparison (e.g. occurrence or potential occurrence of the airspace violation) through, for example, causing the controller (502) to vibrate by a haptic feedback device (e.g. a motor or actuator) of the controller (502), or visually signal via a warning light of the controller (502) or by displaying a message on a display (e.g. display (512)) of the controller (502). Alternatively or additionally, the UAV (501) can include onboard mechanisms that allow it to inform the user (509) of the result of the comparison (e.g. correlation) process. For example, at least one processor of the UAV (501) may control ground-visible warning lights of the UAV (501) to signal the result. As another example, the at least one processor of the UAV (501) may control the UAV (501) to “bob” (rapid oscillating vertical motion). According to embodiments, when one from among the UAV (501) and the controller (502) locally performs the comparison (e.g. correlation) process, the one from among the UAV (501) and the controller (502) may also signal the result (e.g. occurrence or possible occurrence of the airspace violation) of the comparison to the user (509). Alternatively or additionally, the one from among the UAV (501) and the controller (502) may communicate, via the wireless connection (510), a signal codifying the result of the comparison to the other from among the UAV (501) and the controller (502), and the at least one processor of the other from among the UAV (501) and the controller (502) may control the other from among the UAV (501) and the controller (502) to signal the result of the comparison to the user (509).

The embodiments of the present disclosure, described above, can be implemented in both a controller and a UAV as computer software using computer-readable instructions and physically stored in one or more computer-readable media. For example, FIG. 10 shows a computer system (900) suitable for implementing certain embodiments of the disclosed subject matter.

The computer software can be coded using any suitable machine code or computer language, that may be subject to assembly, compilation, linking, or like mechanisms to create code including instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 10 for computer system (900) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (900).

Computer system (900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (901), mouse (902), trackpad (903), touch-screen (910), joystick (905), microphone (906), scanner (907), and camera (908).

Computer system (900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (910), data-glove, or joystick (905), but there can also be tactile feedback devices that do not serve as input devices. For example, such devices may be audio output devices (such as: speakers (909), headphones (not depicted)), visual output devices (such as screens 910 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (900) can also include human accessible storage devices and their associated media such as optical media including CD/DVD ROM/RW (920) with CD/DVD or the like media (921), thumb-drive (922), removable hard drive or solid state drive (923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (900) can also include interface to one or more communication networks. Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (949) (such as, for example USB ports of the computer system (900); others are commonly integrated into the core of the computer system (900) by attachment to a system bus as described below (for example Ethernet interface into a PC computer system or cellular network interface into a smartphone computer system). Using any of these networks, computer system (900) can communicate with other entities. Such communication can be uni-directional, receive only (for example, broadcast TV), uni-directional send-only (for example CANbus to certain CANbus devices), or bi-directional, for example to other computer systems using local or wide area digital networks. Such communication can include communication to a cloud computing environment (955). Certain protocols and protocol stacks can be used on each of those networks and network interfaces as described above.

Aforementioned human interface devices, human-accessible storage devices, and network interfaces (954) can be attached to a core (940) of the computer system (900).

The core (940) can include one or more Central Processing Units (CPU) (941), Graphics Processing Units (GPU) (942), specialized programmable processing units in the form of Field Programmable Gate Areas (FPGA) (943), hardware accelerators (944) for certain tasks, and so forth. These devices, along with Read-only memory (ROM) (945), Random-access memory (RAM) (946), internal mass storage such as internal non-user accessible hard drives, SSDs, and the like, may be connected through a system bus (948). In some computer systems, the system bus (948) can be accessible in the form of one or more physical plugs to enable extensions by additional CPUs, GPU, and the like. The peripheral devices can be attached either directly to the core's system bus (948), or through a peripheral bus (949). Architectures for a peripheral bus include PCI, USB, and the like. A graphics adapter (950) may be included in the core (940).

CPUs (941), GPUs (942), FPGAs (943), and accelerators (944) can execute certain instructions that, in combination, can make up the aforementioned computer code. That computer code can be stored in ROM (945) or RAM (946). Transitional data can be also be stored in RAM (946), whereas permanent data can be stored for example, in the mass storage (947) that is internal. Fast storage and retrieve to any of the memory devices can be enabled through the use of cache memory, that can be closely associated with one or more CPU (941), GPU (942), mass storage (947), ROM (945), RAM (946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system (900) having architecture, and specifically the core (940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (940) that are of non-transitory nature, such as core-internal mass storage (947) or ROM (945). The software implementing various embodiments of the present disclosure can be stored in such devices and executed by core (940). A computer-readable medium can include one or more memory devices or chips, according to particular needs. The software can cause the core (940) and specifically the processors therein (including CPU, GPU, FPGA, and the like) to execute particular processes or particular parts of particular processes described herein, including defining data structures stored in RAM (946) and modifying such data structures according to the processes defined by the software. In addition or as an alternative, the computer system can provide functionality as a result of logic hardwired or otherwise embodied in a circuit (for example: accelerator (944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several non-limiting example embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof

What is claimed is:

1. A method performed by an unmanned aerial system (UAS), the method comprising:
obtaining first digital information that indicates a position of an unmanned aerial vehicle (UAV) of the UAS;
obtaining second digital information that identifies a zone of a Notice to Airmen (NOTAM);
determining whether an airspace violation has occurred by comparing the position of the UAV with the zone of the NOTAM, based on the first digital information and the second digital information; and
controlling the UAS to warn a user of the UAS about the airspace violation occurring or potentially occurring, or controlling the UAV to auto return or land, based on the determining.

2. The method of claim 1, wherein
the second digital information includes one or more parameters that indicate at least one from among a location coordinate of the zone, a radius of the zone, an effective date of the NOTAM, a ceiling of the zone, a floor of the zone, and a status of exemption of the UAV from a prohibition of the NOTAM.

3. The method of claim 2, wherein
the NOTAM is a Temporary Flight Restriction (TFR).

4. The method of claim 2, wherein
at least a portion of the second digital information is in a JavaScript Object Notation (JSON) format.

5. The method of claim 2, wherein
at least a portion of the second digital information has a dictionary data type.

6. The method of claim 1, wherein
the obtaining the second digital information comprises obtaining, by the UAV, the second digital information via a first wireless connection to a network that is external to the UAS, and
the determining whether the airspace violation has occurred is performed by at least one processor of the UAV.

7. The method of claim 1, wherein
the obtaining the second digital information comprises obtaining, by a controller of the UAS, the second digital information via a first wireless connection to a network that is external to the UAS,
the controller comprises at least one processor and is configured to control the UAV via a second wireless connection to the UAV, and
the determining whether the airspace violation has occurred is performed by the at least one processor of the controller of the UAS.

8. The method of claim 1,
the UAS comprises the UAV and a controller configured to control the UAV via a first wireless connection, each of the UAV and the controller comprising at least one processor,
the obtaining the second digital information comprises obtaining, by one from among the UAV and the controller, the second digital information via a second wireless connection to a network that is external to the UAS, and
the determining whether the airspace violation has occurred is performed by the at least one processor of the other from among the UAV and the controller.

9. The method of claim 1, further comprising:
updating an aeronautical chart, that is stored in the UAS, with the second digital information that is obtained.

10. The method of claim 1, wherein the obtaining the second digital information comprises obtaining the second digital information from a server, via a wireless connection to a network that is external to the UAS.

11. An unmanned aerial system (UAS) comprising:
an unmanned aerial vehicle (UAV); and
a controller configured to wirelessly communicate with the UAV and control the UAV,
wherein at least one from among the UAV and the controller comprises:
at least one processor; and
memory comprising computer code, the computer code configured to, when executed by the at least one processor, cause the at least one processor to:
determine whether an airspace violation has occurred by comparing a position of the UAV with a zone of a Notice to Airmen (NOTAM), based on first digital information and second digital information obtained by the at least one processor, and
warn a user of the UAS about the airspace violation occurring or potentially occurring, or controlling the UAV to auto return or land, based on the determination,
the first digital information indicates the position of the UAV, and
the second digital information identifies the zone of the NOTAM.

12. The UAS of claim 11, wherein
the second digital information includes one or more parameters that indicate at least one from among a location coordinate of the zone, a radius of the zone, an effective date of the NOTAM, a ceiling of the zone, a floor of the zone, and a status of exemption of the UAV from a prohibition of the NOTAM.

13. The UAS of claim 12, wherein
the NOTAM is a Temporary Flight Restriction (TFR).

14. The UAS of claim 12, wherein
at least a portion of the second digital information is in a JavaScript Object Notation (JSON) format.

15. The UAS of claim 12, wherein
at least a portion of the second digital information has a dictionary data type.

16. The UAS of claim 11, wherein
the UAV is configured to obtain the second digital information via a wireless connection to a network that is external to the UAS, and
the UAV comprises the memory and the at least one processor, and the UAV is configured to determine whether the airspace violation has occurred based on the first digital information and the second digital information.

17. The UAS of claim 11, wherein
the controller is configured to obtain the second digital information via a first wireless connection to a network that is external to the UAS, and
the controller comprises the memory and the at least one processor, and the controller is configured to determine whether the airspace violation has occurred based on the first digital information and the second digital information.

18. The UAS of claim 11, wherein
one from among the UAV and the controller is configured to obtain the second digital information via a wireless connection to a network that is external to the UAS, and
the other from among the UAV and the controller comprises the memory and the at least one processor and is configured to determine whether the airspace violation has occurred based on the first digital information and the second digital information.

19. The UAS of claim 11, wherein
the computer code is further configured to, when executed by the at least one processor, control the at least one processor to update an aeronautical chart, that is stored in the UAS, with the second digital information that is obtained.

20. A non-transitory computer-readable medium storing computer code that is configured to, when executed by at least one processor of an unmanned aerial system (UAS), cause the at least one processor to:
determine whether an airspace violation has occurred by comparing a position of an unmanned aerial vehicle (UAV) of the UAS with a zone of a Notice to Airmen (NOTAM), based on first digital information and second digital information obtained by the at least one processor of the UAS; and
warn a user of the UAS about the airspace violation occurring or potentially occurring, or control the UAV to auto return or land, based on the determination,
wherein the first digital information indicates the position of the UAV, and
the second digital information identifies the zone of the NOTAM.
